(19) United States
(12) Patent Application Publication
(10) Pub. No.: US 2026/0326671 A1
(43) Pub. Date: Oct. 22, 2026

(54) STORAGE COVER

(71) Applicants: Hyundai Motor Company, Seoul (KR); Kia Corporation, Seoul (KR); NIFCO KOREA INC., Chungcheongnam-do (KR)

(72) Inventors: Jin Won LEE, Gyeonggi-do (KR); Min Woo KWON, Gyeonggi-do (KR); Arom OH, Gyeonggi-do (KR); Chanul JEONG, Gyeonggi-do (KR); Hong Sik CHANG, Gyeonggi-do (KR); Sung Hwan KIM, Gyeonggi-do (KR); Tae Yoon KIM, Gyeonggi-do (KR); Ho Sung SHIN, Gyeonggi-do (KR); Hyo Keun YANG, Chungcheongnam-do (KR)

(21) Appl. No.: 19/326,620

(22) Filed: Sep. 11, 2025

(30) Foreign Application Priority Data
Apr. 16, 2025 (KR) 10-2025-0049691

(51) Int. Cl. B60R 7/04; B60Q 3/225; B60Q 3/62; B60Q 3/82; B60R 11/00

(52) U.S. Cl. CPC B60R 7/04; B60Q 3/225; B60Q 3/62; B60Q 3/82; B60R 2011/0007; B60R 2011/0075

(57) ABSTRACT

Disclosed is a storage cover. The storage cover includes: a cover unit having a predetermined level or higher of transparency and configured to slide and cover a storage space inside a vehicle; and a coating layer applied to cover the cover unit, the coating layer having a surface partially removed to form one or more light transmission portions. Light emitted from inside the storage space is transmitted through the light transmission portions and becomes visible on an exterior of the cover unit.

### CROSS-REFERENCE TO RELATED APPLICATION(S)

This application is based on and claims priority under 35 U.S.C. 119 to Korean Patent Application No. 10-2025-0049691, filed on Apr. 16, 2025, in the Korean Intellectual Property Office, the disclosure of which is herein incorporated by reference in its entirety.

### BACKGROUND OF THE INVENTION

### 1. Field of the Invention

The present disclosure relates to a storage cover that enhances the marketability and quality of a vehicle by applying illumination to a cover that covers a storage space. 2. Description of the Prior Art

Covers used for, for example, a tray, a cup holder, or a glove box inside a vehicle, are used to cover storage spaces to conceal items stored therein, thereby protecting user privacy.

In particular, for a tray, a cover may be used to achieve a neat exterior appearance, and in some cases, various surface treatment methods may be applied to implement a refined surface.

Recently, in accordance with industrial and design trends, there has been a growing demand to enhance the interior of a vehicle to make the interior more luxurious and to improve the marketability and quality of the vehicle by increasingly applying illumination to interior components.

The foregoing described as the background art is intended merely to aid in the understanding of the background of embodiments set forth herein, and should not be construed as meaning that the embodiments fall within the purview of the related art already known to those skilled in the art.

### SUMMARY OF THE INVENTION

Embodiments disclosed herein provide a storage cover that enhances the marketability and quality of a vehicle by applying illumination to a cover that covers a storage space.

The technical subjects pursued in embodiments of the disclosure may not be limited to the above-mentioned technical subjects, and other technical subjects which are not mentioned herein may be clearly understood from the following description by those skilled in the art to which the disclosure pertains.

In view of the foregoing, a storage cover according to a disclosed embodiment may include: a cover unit having a predetermined level or higher of transparency and configured to slide and cover a storage space inside a vehicle; and a coating layer that is applied to cover the cover unit, the coating layer having a surface partially removed to form one or more light transmission portions. Light emitted from inside the storage space is transmitted through the light transmission portions and becomes visible on the exterior of the cover unit.

The cover unit may include: a first cover layer configured to slide along a longitudinal direction of the storage space and including a plurality of sliding panels that are continuously connected and coupled at predetermined intervals in a sliding direction; and a second cover layer formed of a transparent material and coupled to cover the first cover layer. The coating layer is applied to the second cover layer.

The second cover layer may include a light diffusion agent.

The light transmission portions may be formed in a direction orthogonal to a longitudinal direction in which the cover unit slides.

The light transmission portions may be continuously arranged at predetermined intervals in a longitudinal direction in which the cover unit slides.

The storage cover may include a lighting unit configured to emit light into the storage space, and the light emitted from the lighting unit may illuminate a specific pattern such that a shape of the pattern becomes visible on the exterior of the cover unit.

The storage cover may include a first light guide that is provided on an inner surface of a storage housing defining the storage space and configured such that the light emitted from the lighting unit is transmitted through the first light guide and diffused toward the cover unit. The pattern may be formed in the first light guide such that the shape of the pattern becomes visible on the exterior of the cover unit by the light diffused from the first light guide.

The shape of the pattern may be formed by partially removing the coating layer such that the shape of the pattern becomes visible on the exterior of the cover unit by the light emitted from the lighting unit.

The storage cover may include a lighting unit configured to emit light into the storage space, and a second light guide configured such that the light emitted from the lighting unit is transmitted therethrough, propagated along a longitudinal direction of the cover unit, and diffused toward the cover unit.

The second light guide may include: a first guide that is provided along a longitudinal direction adjacent to a lower portion of the cover unit and into which the light from the lighting unit is incident at an end portion thereof and is propagated along the longitudinal direction thereof; and a second guide provided to surround the first guide and to face the cover unit and configured such that the light transmitted from the first guide is incident on the second guide and diffused toward the cover unit.

A single lighting unit may be disposed at an end portion of the second light guide.

The cover unit may be divided into an illumination region adjacent to the second light guide and a remaining non-illumination region, and a blocking rib may protrude downward toward the storage space between the illumination region and the non-illumination region to block light diffused from the second light guide.

The second light guide may have a groove-shaped notch extending in a radial direction such that the light, which is propagated along a longitudinal direction of the second light guide, is guided in the radial direction toward the cover unit.

The cross-sectional groove size of the notch may increase as a distance from the lighting unit increases.

The storage cover may include a lighting unit configured to emit light into the storage space, and one or more third light guides configured such that the light emitted from the lighting unit is transmitted therethrough, propagated along a widthwise direction of the cover unit, and diffused toward the cover unit.

The third light guides may be fixed along a widthwise direction of the cover unit, and light from the lighting unit may be incident on an end portion of each of the third light guides.

The third light guides may be continuously arranged at predetermined intervals along the longitudinal direction of the cover unit, and the lighting unit may be individually provided for each of the third light guides so that light is incident thereon.

The storage cover may include: rails configured to guide sliding of the cover unit on left and right sides of the cover unit. Each of the rails has projection holes at portions respectively facing the third light guides, light emitted from the lighting unit may be incident on the third light guides through the projection holes, and each of the projection holes may have an inner diameter that expands toward a corresponding one of the third light guides.

The third light guides may each be disposed at a position corresponding to the lighting unit in response that the storage space is closed by the cover unit.

The storage cover may further include: a sensor configured to detect whether the storage space is opened or closed by the cover unit; and a controller configured to control on/off operation of the lighting unit in response to opening or closing of the storage space.

According to the embodiments disclosed herein, by applying illumination to the surface of the cover, illumination may be arranged on various interior cover components of the vehicle, thereby ensuring uniform light distribution and enhancing the premium feel of the vehicle. As a result, the design marketability may be maximized, sales appeal may be improved, and customer satisfaction may be increased.

Furthermore, as the light transmission portions are continuously formed in a line shape along the direction in which the cover unit slides, the coating layer is divided into band-shaped sections. Accordingly, quality issues may be mitigated by preventing cracks that may occur in the coating layer. Furthermore, the lines of the light transmission portions may become clearly visible, resulting in a clean exterior appearance of the cover.

Advantageous effects obtainable from embodiments set forth herein may not be limited to the above-mentioned effects, and other effects which are not mentioned herein may be clearly understood from the following description by those skilled in the art to which the embodiments pertain.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a view illustrating a state in which a cover is closed on a tray according to an embodiment of the present disclosure;

FIG. 2 is a view illustrating a state in which the cover is opened on the tray according to an embodiment of the present disclosure;

FIG. 3 is a view illustrating a cover according to an embodiment of the present disclosure;

FIG. 4 is a view illustrating a cross-section of the cover and a light transmission portion according to an embodiment of the present disclosure;

FIG. 5 is a view illustrating an embodiment in which a lighting unit of the present disclosure is applied;

FIG. 6 is a view illustrating a configuration in which the lighting unit of the present disclosure is installed on side portions of a storage housing;

FIG. 7 is a view illustrating a lighting module applied to FIGS. 5 and 6;

FIG. 8 is a view illustrating an embodiment in which a single lighting unit is applied according to the present disclosure;

FIG. 9 is a view illustrating a structure in which the components of FIG. 8 are assembled;

FIG. 10 is a view illustrating how light from the lighting unit is diffused into the cover in FIG. 9;

FIG. 11 is a view illustrating a structure in which a blocking rib is formed on the lower portion of the cover in FIG. 9;

FIG. 12 is a view illustrating a structure in which a notches are formed in the second light guide of FIG. 8;

FIG. 13 is a view illustrating an embodiment in which separate lighting units are applied to respective light guides according to the present disclosure;

FIG. 14 is a view illustrating a structure in which the components of FIG. 13 are assembled;

FIG. 15 is a view illustrating how light from the lighting unit is diffused into the cover in FIG. 14;

FIG. 16 is a view illustrating a method of fixing third light guides of FIG. 13 to the cover unit; and

FIG. 17 is a view illustrating a structure in which light from the lighting unit is provided through expanded transmission holes in FIG. 14.

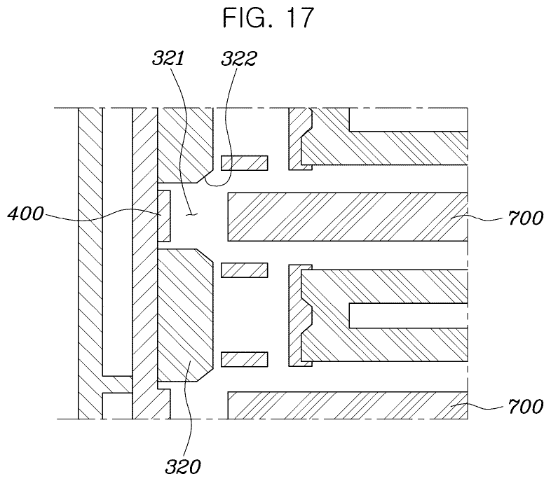

### DETAILED DESCRIPTION OF THE EXEMPLARY EMBODIMENTS

In describing the embodiments set forth herein, a detailed description of known functions or configurations incorporated herein will be omitted when it is determined that the description may make the subject matter of the embodiments set forth herein unclear. In addition, it should be appreciated that the accompanying drawings are provided only for the sake of easy understanding of the embodiments set forth herein, and the technical idea of the present disclosure is not limited to the accompanying drawings and includes all modifications, equivalents, or alternatives falling within the spirit and scope of the present disclosure. The following descriptions are not intended to limit the present disclosure to the described form or specific field, and it is considered that various alternative modifications and changes may be made to the present disclosure regardless of whether the descriptions are explicit or implicit. Those skilled in the art to which the present disclosure pertains will appreciate that the contents of the present disclosure may be changed in forms and details.

The present disclosure will be described with reference to specific embodiments. However, as understood by a person ordinarily skilled in the art to which the present disclosure pertains, various aspects disclosed herein may be modified or otherwise implemented in different ways without departing from the spirit and scope of the present disclosure. Accordingly, the following description is to be considered exemplary, and is intended to teach those ordinarily skilled in the art to which the disclosure belongs how to make and use various embodiments. It is to be understood that the forms of the disclosure illustrated and described herein are exemplary embodiments. Equivalent elements, materials, processes, or steps may be substituted for those exemplified and described in the present disclosure. Expressions used in the present disclosure, such as “including,” “comprising,” “incorporating,” “consisting of,” “have,” or “is,” should be interpreted in a non-exclusive manner, i.e., to allow for the inclusion of items, components, or elements not explicitly listed. In addition, references to the singular form should be interpreted to include the plural form as well.

Furthermore, the various embodiments disclosed herein should be regarded as exemplary and descriptive, and should not be construed as limiting the scope of the present disclosure. All references to joining (e.g., attached, affixed, coupled, and connected) are used solely to facilitate understanding of the present disclosure and are not intended to limit the position, orientation, or use of any component or method disclosed herein. Accordingly, references to joining should be interpreted broadly. Moreover, these references to joining do not imply that two or more elements are directly connected to each other. In addition, all numerical terms, such as “first,” “second,” “third,” “primary,” “secondary,” “main,” or any other generic terms or numerical expressions, are to be understood solely as identifiers to aid in the understanding of the various components, embodiments, modifications, or variations of the present disclosure, and do not imply any limitations as to any component, embodiment, modification, variation, or their order or preference. That is, these terms may be used to describe various components but should not be construed as limiting the components to those terms. These terms are used only to distinguish one component from another.

The terms “module” and “unit” used for the elements in the following description are given or interchangeably used in consideration of only the ease of writing the specification, and do not have distinct meanings or roles by themselves.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

In addition, a unit or a control unit included in names is merely a term widely used for naming a controller configured to control a specific function of a vehicle, but does not mean a generic function unit.

In order to control functions in charge, a controller may include a communication device configured to communicate with a sensor or another controller, a memory configured to store an operating system or logic instructions and input/output information, and at least one processor configured to perform determination, calculation, decision, or the like required for control of the functions in charge.

Any number or variety of components in any of the configurations described herein may be included within the scope of the present disclosure described herein. The components may include any combination of the features described herein and may be arranged in any of the various configurations described herein. The concepts related to the structure and arrangement of the components of the present disclosure, as well as their use and operation, may be applied to any number of embodiments in any combination, as well as to the specific embodiments discussed herein. Embodiments including those having various features in various arrangements are described below with reference to the drawings.

Hereinafter, various embodiments set forth herein will be described in detail with reference to the accompanying drawings, and the same or similar elements are given the same and similar reference numerals regardless of figure numbers, so duplicate descriptions thereof will be omitted.

A storage cover 10 according to an embodiment of the disclosure includes: a cover unit 100 having a predetermined level or higher of transparency and configured to slide and cover a storage space 310 inside a vehicle; and a coating layer 200 applied to cover the cover unit 100, the coating layer having a surface that is partially removed to form one or more light transmission portions 210. Light emitted from inside the storage space 310 is transmitted through the light transmission portion 210 and becomes visible on an exterior of the cover unit 100.

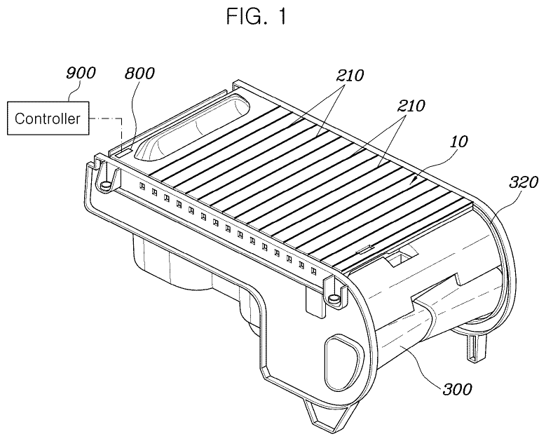

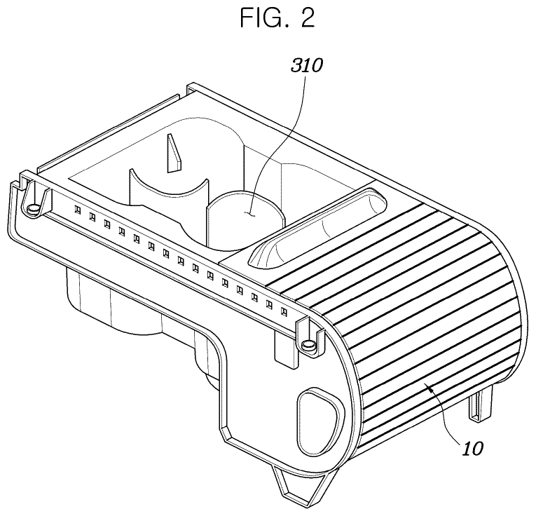

The cover 10 illustrated in FIGS. 1 and 2 is an example of a cover for a vehicle tray.

Hereinafter, an embodiment of the disclosure will be described with reference to the drawings. A box-shaped storage housing 300 with an open top is provided inside a vehicle.

Inside the storage housing 300, a storage space 310 is defined to store items, and a cover unit 100 is provided to cover the storage space 310.

Rails 320 are provided on left and right sides of the storage housing 300. The cover unit 100 is slidable along the rails 320, with its left and right sides respectively inserted into grooves formed in the rails. Accordingly, the storage space 310 may be opened or closed by the sliding of the cover unit 100.

Upper surfaces of the rails 320 are formed horizontally. However, rear ends of the rails 320 are formed to extend in an arc shape at the rear end of the storage housing 300.

Accordingly, as the cover unit 100 slides, the rear end of the cover unit 100 follows the arc shape of the rails 320.

The cover unit 100 is formed to have a transparency of a predetermined level or higher.

A coating layer 200 is applied to the surface of the cover unit 100 and may be double-coated with an upper coating 200a and a lower coating 200b.

The upper coating 200a may be applied using, for example, a soft paint, a metallic paint, or a bio paint, and the lower coating 200b may be applied using a black primer to shield the transparent cover unit 100 while implementing various colors.

In particular, a part of the coating layer 200 is partially removed, and the removed portions become light transmission portions 210.

As the coating layer 200 is removed, light is able to pass through the light transmission portions 210.

Accordingly, when light is emitted from inside the storage space 310, the light does not pass through the portions where the coating layer 200 remains, but is emitted outward through the light transmission portions 210 where the coating layer 200 has been removed, so that the light is visible on the exterior of the cover unit 100.

Therefore, by applying illumination to the surface of the cover 10, the illumination may be provided on various cover components inside the vehicle, thereby ensuring uniform light distribution and enhancing the premium feel of the vehicle. As a result, the design marketability may be maximized, sales appeal may be improved, and customer satisfaction may be increased.

In addition, in a disclosed embodiment, the cover unit 100 includes: a first cover layer 110 configured to slide along a longitudinal direction of the storage space 310 and including a plurality of sliding panels 111 that are continuously connected and coupled at predetermined intervals in a sliding direction; and a second cover layer 120 formed of a transparent material and coupled to cover the first cover layer 110. The coating layer 200 is applied to the second cover layer 120.

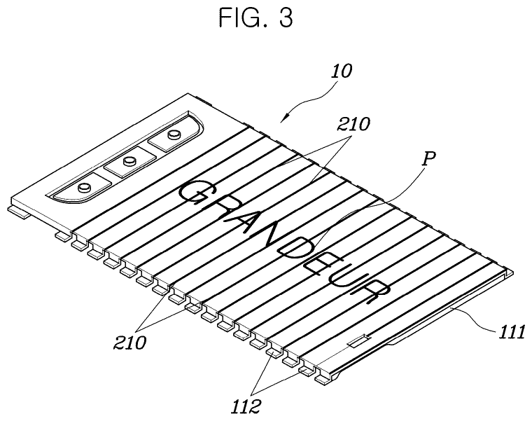

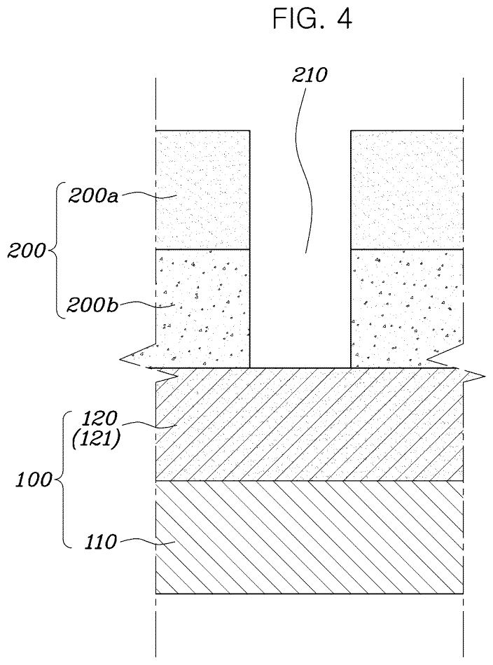

Referring to FIGS. 3 and 4, the cover unit 100 is configured by coupling the second cover layer 120 to the upper surface of the first cover layer 110.

The first cover layer 110 includes a plurality of rectangular sliding panels 111 having a short widthwise length. The rectangular sliding panels 111 are disposed to extend in the left-right widthwise direction of the cover unit 100 and are continuously connected at predetermined intervals along a front-rear longitudinal direction of the cover unit 100.

In addition, slidable or rollable rollers are provided on respective left and right sides of the sliding panels 111, and the rollers are inserted into the rails 320 such that the sliding panels 111 slide along the rails 320.

In particular, the continuously connected sliding panels 111 are foldably connected to each other, so that the first cover layer 110 moves along the arc-shaped rear ends of the rails 320.

Accordingly, the sliding panels 111 may be made of a material with excellent stability and high material reliability, such as a PP-based or PC-based material.

In addition, the second cover layer 120 is configured in a plate shape capable of entirely covering the first cover layer 110, and is fixed to the upper surface of the first cover layer 110.

The coating layer 200 is applied to an upper surface of the second cover layer 120.

In particular, as the light transmission portions 210 are formed in the coating layer 200, the second cover layer 120 may be made of a transparent TPE-based material that exhibits excellent transparency and diffusivity and allows light to easily pass therethrough.

In addition, the second cover layer 120 may include a light diffusion agent 121.

Accordingly, the light passing through the second cover layer 120 may be evenly diffused to provide a natural illumination effect.

For example, the light diffusion agent 121 may be included in the second cover layer 120 as an additive during injection molding of the second cover layer 120.

In another example, the light diffusion agent 121 may be fixed to a surface of the second cover layer 120 in the form of a film.

Furthermore, the light transmission portions 210 may be formed in a direction orthogonal to a longitudinal direction in which the cover unit 100 slides.

In particular, the light transmission portions 210 may be continuously arranged at predetermined intervals in the longitudinal direction in which the cover unit 100 slides.

That is, as illustrated in FIGS. 1 and 3, the light transmission portions 210 are formed in the shape of linear grooves extending along a widthwise direction of the cover unit 100, and the linear light transmission portions 210 are arranged at predetermined intervals along the longitudinal direction of the cover unit 100.

In detail, unless the light transmission portions 210 are formed, cracks may occur on the surface of the coating layer 200 due to a decrease in elongation of the coating layer 200 while the cover unit 100 moves along the arc shape.

Accordingly, in the disclosed embodiment, by continuously forming the linear light transmission portions 210 along the sliding direction of the cover unit 100, the coating layer 200 is divided into band-shaped sections.

Therefore, quality issues may be mitigated by preventing cracks that may occur in the coating layer 200. Furthermore, the lines of the light transmission portions 210 become clearly visible, resulting in a clean exterior appearance of the cover 10.

In addition, as illustrated in FIG. 4, the light transmission portions 210 may be formed by laser cutting the coating layer 200.

That is, the upper coating 200a and the lower coating 200b may be laser-cut to form the light transmission portions 210.

Of course, in addition to laser cutting, other methods such as a scraping technique or a masking process may be used to remove the coating layer 200.

Furthermore, the light transmission portions 210 may be formed at an interval no greater than a predetermined value.

That is, the longitudinal interval between adjacent light transmission portions 210 may be about 0.3 mm.

If the longitudinal interval between adjacent light transmission portions 210 is too large, the first cover layer 110 may be excessively exposed through the light transmission portions 210, resulting in a degraded external appearance of the cover 10. On the other hand, if the longitudinal interval between adjacent light transmission portions 210 is too small, the lines of the light transmission portions 210 may become blurred, thereby deteriorating the illumination function through the light transmission portions 210.

Meanwhile, in an embodiment in which a lighting unit 400 according to the present disclosure is applied, the storage cover includes a lighting unit 400 configured to emit light inside the storage space 310, and the light emitted from the lighting unit 400 illuminates a specific pattern P such that the shape of the pattern P becomes visible on the exterior of the cover unit 100.

Referring to FIGS. 3, 5, and 7, the lighting unit 400 may be an LED embedded in a lighting module M, and the lighting module M may be installed at the lower portion of the storage housing 300.

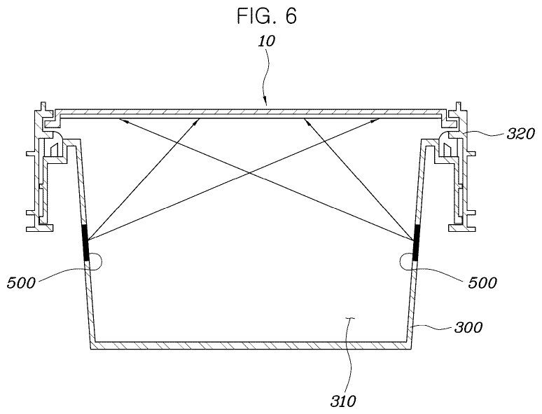

In another example, as illustrated in FIG. 6, the lighting module M may be installed at a side portion of the storage housing 300.

Accordingly, the light emitted from the lighting unit 400 is directed toward the upper cover unit 100 within the storage space 310.

In particular, the light directed toward the cover unit 100 may illuminate the specific pattern P.

The pattern P may include characters or graphics, such as a vehicle brand, name, or logo.

Accordingly, as the shape of the pattern P is projected toward the cover unit 100 within the storage space 310, the shape of the pattern P becomes visible from the exterior of the cover 10, thereby enhancing the interior effect of the vehicle.

In an embodiment in which a pattern P is implemented on the cover unit 100, a first light guide 500 is provided on an inner surface of the storage housing 300 defining the storage space 310 and configured such that the light emitted from the lighting unit 400 is transmitted through the first light guide 500 and diffused toward the cover unit 100. The pattern P may be formed in the first light guide 500 such that the shape of the pattern P becomes visible on the exterior of the cover unit 100 by the light diffused from the first light guide 500.

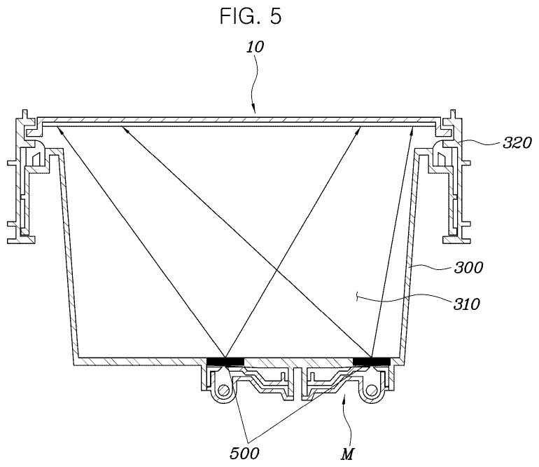

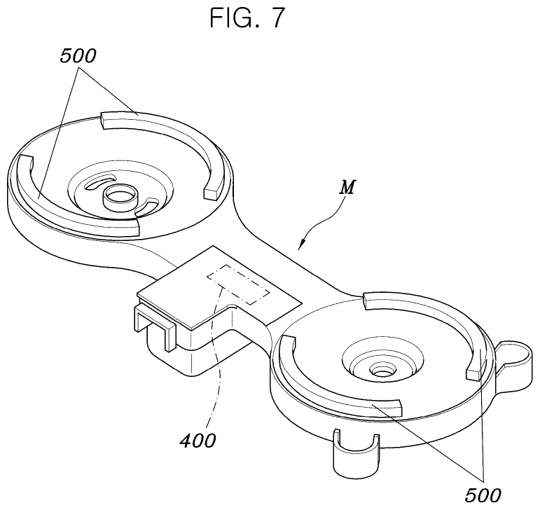

Referring to FIGS. 5 and 7, the lighting module M includes arc-shaped first light guides 500 provided on an upper surface thereof to be exposed to an inner surface of the storage housing 300.

Accordingly, light emitted from the lighting unit 400 is propagated to the first light guides 500 and is diffused through the first light guides 500. Then, the diffused light is directed from inside the storage space 310 toward the upper cover unit 100.

In particular, a pattern P may be formed on a surface of each of the first light guides 500.

For example, the surface of each of the first light guides 500 may be coated with paint, and the coated surface may be partially removed in the shape of the pattern P to form the pattern P.

In another example, a pattern P may be formed on the surface of each of the first light guides 500 during injection molding of the first light guides 500.

Accordingly, since the shape of the pattern P is illuminated by the light diffused from the first light guides 500, passes through the light transmission portions 210, and becomes visible on the exterior of the cover unit 100.

In another embodiment in which the pattern P is implemented in the cover unit 100, the shape of the pattern P is formed by partially removing the coating layer 200 such that the shape of the pattern P becomes visible on the exterior of the cover unit 100 by light emitted from the lighting unit 400.

That is, the pattern P is formed by partially removing a portion of the coating layer 200 in the shape of the pattern P.

In addition, light may be transmitted through the portion where the coating layer 200 has been removed to form the pattern P.

When light is emitted from inside the storage space 310, light does not pass through the remaining portions of the coating layer 200, but passes through portions where the coating layer 200 is removed to form the pattern, so that the shape of the pattern P becomes visible on the exterior of the cover unit 100.

For reference, the pattern P formed in the coating layer 200 may be formed in the same manner as the light transmission portions 210.

Meanwhile, as another embodiment in which a lighting unit 400 is applied, the storage cover includes: a lighting unit 400 configured to emit light into the storage space 310; and a second light guide 600 configured such that the light emitted from the lighting unit 400 is transmitted therethrough, propagated along the longitudinal direction of the cover unit 100, and diffused the light toward the cover unit 100.

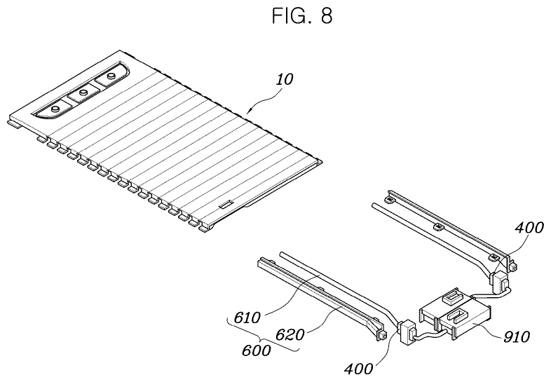

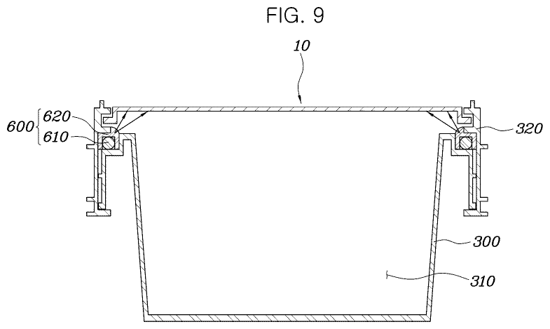

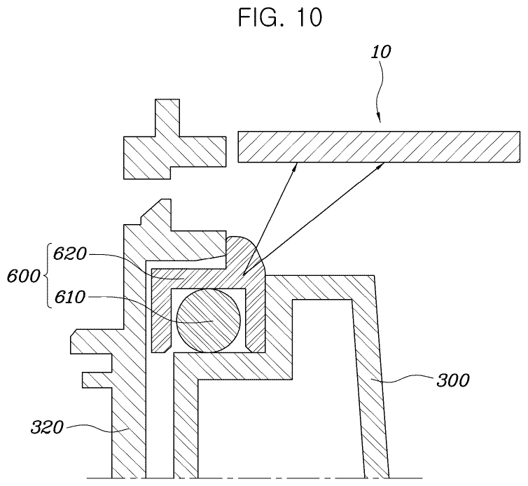

Referring to FIGS. 8 to 10, the second light guide 600 is arranged to extend in a front-rear longitudinal direction of the cover unit 100 on each of the left and right sides of the cover unit 100.

In addition, the light emitted from the lighting unit 400 is propagated along the longitudinal direction of the second light guide 600 and diffused toward the cover unit 100.

Accordingly, the light from the lighting unit 400 may illuminate each of the left and right sides of the cover 10.

In addition, the second light guide 600 includes: a first guide 610 provided along a longitudinal direction adjacent to a lower portion of the cover unit 100 and configured such that the light from the lighting unit 400 is incident on an end portion of the first guide and propagated along the longitudinal direction thereof; and a second guide 620 provided to surround the first guide 610 and to face the cover unit 100 and configured such that the light transmitted through the first guide 610 is incident on the second guide and diffused toward the cover unit 100.

Referring to FIGS. 8 to 10, the first guide 610 has an elongated cylindrical rod shape and is disposed along the front-rear longitudinal direction at each of the left and right upper sides of the storage housing 300, adjacent to a lower side of the cover 10.

Light from the lighting unit 400, which includes an LED, is incident on an end portion of the first guide 610 and is propagated along the longitudinal direction of the first guide 610.

The second guide 620 has a U-shaped cross section and is fixed to cover left, right, and upper sides of the first guide 610.

The outer surface and a portion of an upper side of the second guide 620 are blocked by rails 320, and a portion of an inner surface and a lower side of the second guide 620 are blocked by the storage housing 300.

Accordingly, light propagated to the first guide 610 from the lighting unit 400 is diffused in a radial direction and is incident on the second guide 620. The light incident on the second guide 620 is further diffused while being concentrated in an upper inward direction.

As a result, the light diffused from the lighting unit 400 is directed onto the cover 10, and the light directed onto the cover 10 is transmitted through the light transmission portion 210, thereby implementing illumination on the exterior of the cover 10.

In addition, a single lighting unit 400 may be disposed at an end portion of each of the second light guides 600.

That is, as illustrated in FIG. 8, by connecting the lighting unit 400 to only one side of each of the first guides 610 arranged on the left and right sides, light from the lighting unit 400 is propagated along the longitudinal direction of the first guides 610 and illuminates the left and right sides of the cover.

Accordingly, indirect illumination may be softly implemented on the left and right sides of the cover 10.

In addition, the cover unit 100 may be divided into an illumination region adjacent to the second light guide 600 and a remaining non-illumination region, and a blocking rib 130 may protrude downward toward the storage space 310 between the illumination region and the non-illumination region so as to block light diffused from the second light guide 600.

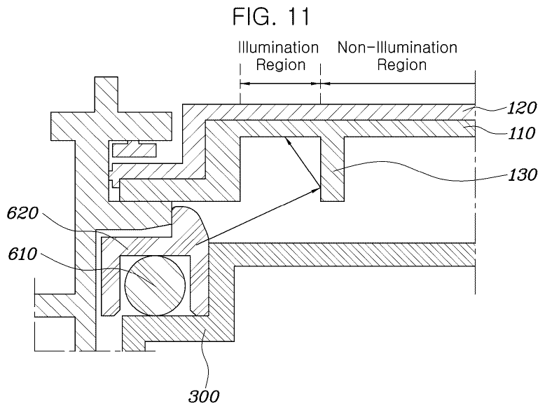

Referring to FIG. 11, an illumination region is formed on each of the left and right sides of the cover unit 100 adjacent to a corresponding one of the second light guides 600, and a non-illumination region is formed between the left and right illumination regions.

In particular, a blocking rib 130 is formed between the non-illumination region and each of the illumination regions, and the blocking rib 130 protrudes downward in a direction perpendicular to a lower surface of the first cover layer 110.

Accordingly, light diffused from the second light guides 600 toward the cover 10 is incident on the illumination regions so as to illuminate the illumination regions.

However, light diffused toward the blocking rib 130 is blocked by the blocking rib 130, so that light is prevented from being incident on the non-illumination region and illumination is not implemented in a central portion of the cover 10.

However, the light diffused to the blocking rib 130 may be reflected toward the illumination regions, which increases the amount of light incident on the illumination regions.

Accordingly, illumination having uniform luminance may be implemented in the illumination regions formed on the left and right sides of the cover 10.

In addition, the second light guide 600 may have a groove-shaped notch 611 extending in a radial direction so that the light propagated along the longitudinal direction of the second light guide 600 is guided radially toward the cover unit 100.

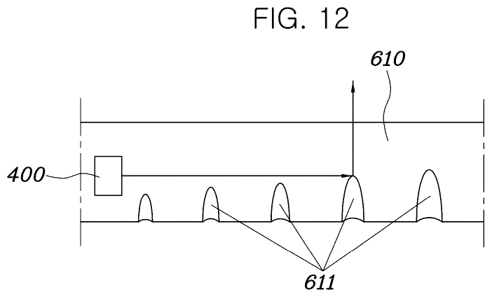

Referring to FIG. 12, notches 611 are formed in a radial direction on an outer surface of the first guide 610.

Accordingly, when light propagated along the first guide 610 strikes the notches 611, the light is refracted in a perpendicular direction.

In particular, the notches 611 are formed so that the light refracted upon striking the notches 611 is refracted toward the cover 10.

Therefore, as the light propagated through the first guide 610 is guided toward the cover 10, illumination having uniform luminance may be implemented in the illumination regions formed on the left and right sides of the cover 10.

Furthermore, the notches 611 increase in groove cross-sectional size as a distance from the lighting unit 400 increases.

Referring to FIG. 12, the notches 611 are repeatedly formed at predetermined intervals along a longitudinal direction of the first guide 610, and a lighting unit 400 is connected to one end of the first guide 610.

Accordingly, the notch 611 closest to the one end of the first guide 610 has the smallest groove cross-section, and the groove cross-sections of the notches 611 gradually increase toward the other end of the first guide 610. Thus, the notch 611 closest to the other end of the first guide 610 has the largest groove cross-section.

Therefore, even at positions of the first guide 610 that are far from the lighting unit 400, light may be smoothly reflected from the first guide 610 toward the cover 10, so that illumination with uniform luminance is implemented in front and rear portions of the cover 10.

Meanwhile, as another embodiment in which a lighting unit 400 according to the present disclosure 400 is applied, the storage cover includes: one or more lighting units 400 configured to emit light into the storage space 310; and one or more third light guides 700 configured such that the light emitted from the lighting units 400 is transmitted therethrough, propagated along a widthwise direction of the cover unit 100, and diffused toward the cover unit 100.

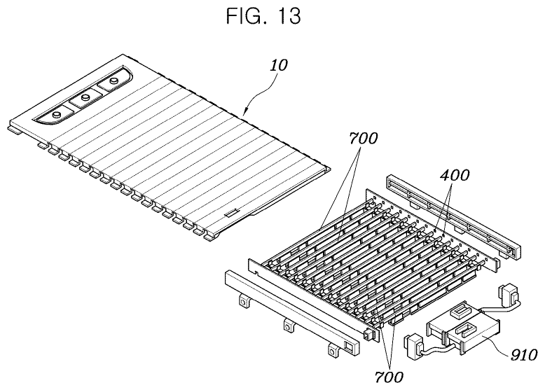

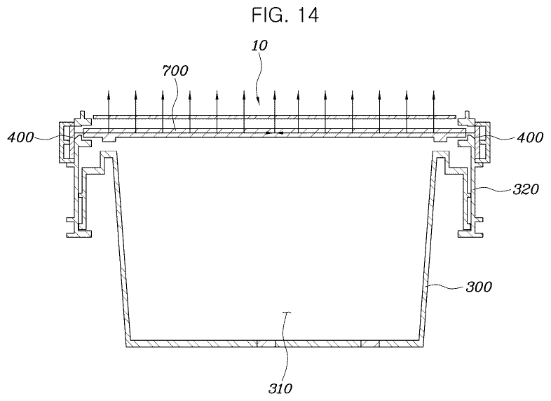

Referring to FIGS. 13 to 15, the third light guides 700 are arranged to extend in a widthwise direction across the left and right sides of the cover unit 100.

Light emitted from the lighting units 400 is propagated along a longitudinal direction of the third light guides 700 and is diffused toward the cover unit 100.

Accordingly, light from the lighting units 400 may illuminate the entire width of the cover 10.

In addition, the third light guides 700 are fixed along the widthwise direction of the cover unit 100, and light from each of the lighting units 400 is incident on an end portion of a corresponding one of the third light guides 700.

Referring to FIGS. 13 to 15, the third light guides 700 are arranged to extend in the widthwise direction across the left and right sides of an upper portion of the storage housing 300.

The third light guides 700 are fixedly welded to the cover unit 100, and slide together with the cover 10.

Light from each of the lighting units 400, which includes an LED, is incident on the left and right end portions of a corresponding one of the third light guides 700, and is propagated along the longitudinal direction to the left and right sides of the third light guides 700.

Accordingly, the light propagated to the third light guides 700 from the lighting units 400 is diffused in a radial direction toward the upper cover 10.

As a result, the light diffused from the lighting units 400 is directed onto the cover 10, and the light directed onto the cover 10 is transmitted through the light transmission portions 210, so as to implement illumination on the exterior of the cover 10.

Furthermore, the third light guides 700 may be continuously arranged at predetermined intervals along the longitudinal direction of the cover unit 100, and the lighting units 400 may be individually provided for the respective third light guides 700 such that light is incident thereon.

Referring to FIG. 13, the third light guides 700 are continuously arranged at predetermined intervals along the front-rear longitudinal direction of the cover unit 100.

The third light guides 700 are respectively disposed between sliding panels 111 of the first cover layer 110.

Each of the third light guides 700 is positioned below a corresponding one of the light transmission portions 210, so that light diffused from the third light guides 700 can be smoothly transmitted through the light transmission portions 210.

As such, since the third light guides 700 are individually arranged for the respective light transmission portions 210 and light from the lighting units 400 is directed thereto, illumination may be implemented directly across the entire region of the cover 10.

In addition, as the third light guides 700 are fixed to the cover 10, the rigidity of the cover 10 is increased. Accordingly, when the cover 10 is closed, the cover 10 may function as a bottom plate of an open-type tray, which improves space utilization and minimizes operational play with the rails 320.

However, since the lighting units 400 are connected to both the left and right ends of the third light guides 700, the left and right end portions of the third light guides 700 may be excessively illuminated compared to the middle portions.

Accordingly, left and right regions of the cover unit 100 corresponding to the left and right ends of the third light guides 700 may be configured such that the coating layer 200 is left uncut, so that no light transmission portion 210 is formed.

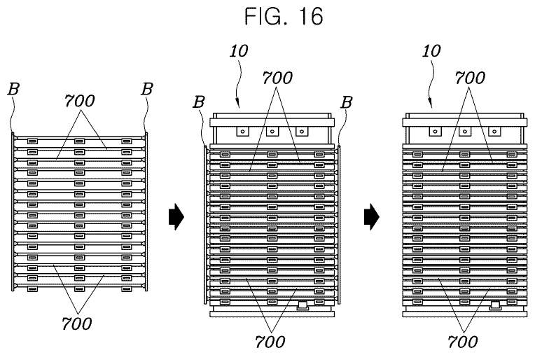

For reference, a method of fixing a plurality of third light guides 700 to the cover 10 will be described with reference to FIG. 16, in which bridges B are injection-molded together on the left and right sides of the third light guides 700 to integrally fabricate the third light guides 700.

Then, the integrated third light guides 700 are fixedly welded to the cover unit 100, and the left and right bridges B are removed, so that the plurality of third light guides 700 can be easily fixed to the cover unit 100.

Moreover, the storage cover may include rails 320 configured to guide sliding of the cover unit 100 at the left and right sides thereof. Each of the rails 320 may have projection holes 321 at portions respectively facing the third light guides 700, light emitted from the lighting units 400 may be incident on the third light guides 700 through the projection holes 321, and each of the projection holes 321 may have an inner diameter that expands toward a corresponding one of the third light guides 700.

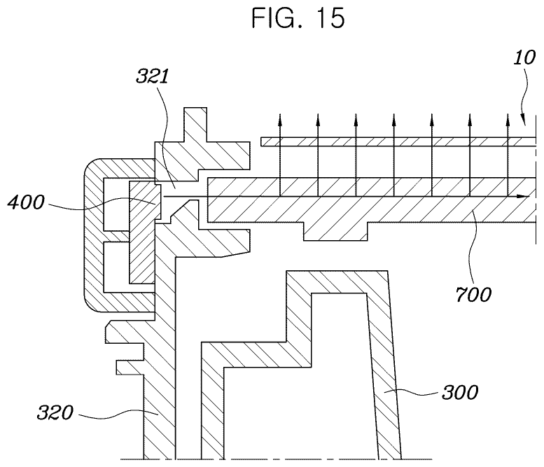

Referring to FIG. 15, the rails 320 are disposed on the left and right of the third light guides 700, and the lighting units 400 are disposed on outer sides of the rails 320.

The projection holes 321 are formed through portions of the rails 320 where opposite end portions of the third light guides 700 face the lighting units 400, so that light emitted from the lighting units 400 is incident on the third light guides 700 through the projection holes 321.

In particular, chamfers 322 are formed on inner surfaces of the projection holes 321 that are close to the third light guides 700, such that the inner diameters of the projection holes 321 expand toward the third light guides 700 from the lighting units 400.

Accordingly, as the light provided from the lighting units 400 expands through the projection holes 321 and is incident on the third light guides 700, soft illumination may be provided through the cover 10.

Meanwhile, in an embodiment disclosed herein, the third light guides 700 are disposed at positions corresponding to the lighting units 400 in response that the storage space 310 is closed by the cover unit 100.

That is, the third light guides 700 slide together with the cover 10, whereas the lighting units 400 are fixed to side surfaces of the respective rails 320 and do not slide.

Accordingly, by configuring the third light guides 700 and the lighting units 400 to be aligned with each other when the cover 10 is in the closed state, illumination may be provided to the exterior of the cover 10 while the cover 10 is closed.

Meanwhile, the storage cover according to an embodiment disclosed herein further includes: a sensor 800 configured to detect whether the storage space 310 is opened or closed by the cover unit 100; and a controller 900 configured to control on/off operation of the lighting units 400 in response to the opening or closing of the storage space 310.

Referring to FIG. 1, the sensor 800 may be a switch fixed to a front end of the cover 10 or to an inner surface of the storage housing 300 facing the front end, and configured to be turned on or off in response to the opening or closing of the cover 10.

Accordingly, when the cover 10 is closed, the switch is turned on to detect that the storage space 310 is in a closed state, and when the cover 10 is opened, the switch is turned off to detect that the storage space 310 is in an open state.

In particular, when the cover 10 is closed and the switch is turned on, the controller 900 may turn on the lighting units 400 to implement illumination on the cover 10. When the cover 10 is opened and the switch is turned off, the controller 900 may turn off the lighting units 400 so as not to implement illumination on the cover 10.

The controller 900 may implement various color illumination in cooperation with a mood lamp controller 910, and may be capable of implementing a dynamic design in connection with an interactive lighting scenario (including sequential lighting).

Although the present disclosure has been described and illustrated in conjunction with particular embodiments thereof, it will be apparent to those skilled in the art that various improvements and modifications may be made to the present disclosure without departing from the technical idea of the present disclosure defined by the appended claims.

What is claimed is:

1. A storage cover comprising:
a cover unit having a predetermined level or higher of transparency and configured to slide and cover a storage space inside a vehicle; and
a coating layer applied to cover the cover unit, the coating layer having a surface thereof partially removed to form one or more light transmission portions, wherein light emitted from inside the storage space is transmitted through the light transmission portions and becomes visible on an exterior of the cover unit.

2. The storage cover of claim 1, wherein the cover unit comprises:
a first cover layer configured to slide along a longitudinal direction of the storage space and comprising a plurality of sliding panels that are continuously connected and coupled at predetermined intervals in a sliding direction; and
a second cover layer formed of a transparent material and coupled to cover the first cover layer, wherein the coating layer is applied to the second cover layer.

3. The storage cover of claim 2, wherein the second cover layer comprises a light diffusion agent.

4. The storage cover of claim 1, wherein the light transmission portions are formed in a direction orthogonal to a longitudinal direction in which the cover unit slides.

5. The storage cover of claim 1, wherein the light transmission portions are continuously arranged at predetermined intervals in a longitudinal direction in which the cover unit slides.

6. The storage cover of claim 1, further comprising:
a lighting unit configured to emit light into the storage space,
wherein the light emitted from the lighting unit illuminates a specific pattern such that a shape of the pattern becomes visible on the exterior of the cover unit.

7. The storage cover of claim 6, further comprising:
a first light guide provided on an inner surface of a storage housing defining the storage space, and configured such that the light emitted from the lighting unit is transmitted therethrough and diffused toward the cover unit,
wherein the pattern is formed in the first light guide such that the shape of the pattern becomes visible on the exterior of the cover unit by the light diffused from the first light guide.

8. The storage cover of claim 6, wherein the shape of the pattern is formed by partially removing the coating layer such that the shape of the pattern becomes visible on the exterior of the cover unit by the light emitted from the lighting unit.

9. The storage cover of claim 1, further comprising:
a lighting unit configured to emit light into the storage space; and
a second light guide configured such that the light emitted from the lighting unit is transmitted therethrough, propagated along a longitudinal direction of the cover unit, and diffused toward the cover unit.

10. The storage cover of claim 9, wherein the second light guide comprises:
a first guide provided along a longitudinal direction adjacent to a lower portion of the cover unit and configured such that the light from the lighting unit is incident on an end portion thereof and propagated along the longitudinal direction thereof; and
a second guide provided to surround the first guide and to face the cover unit and configured such that the light transmitted from the first guide is incident on the second guide and diffused toward the cover unit.

11. The storage cover of claim 9, wherein a single lighting unit is disposed at an end portion of the second light guide.

12. The storage cover of claim 9, wherein the cover unit is divided into an illumination region adjacent to the second light guide and a remaining non-illumination region, and
wherein a blocking rib protrudes downward toward the storage space between the illumination region and the non-illumination region to block light diffused from the second light guide.

13. The storage cover of claim 9, further comprising:
a groove-shaped notch formed in a radial direction of the second light guide such that the light propagated along a longitudinal direction of the second light guide is guided in the radial direction toward the cover unit.

14. The storage cover of claim 13, wherein the notch increases in cross-sectional groove size as a distance from the lighting unit increases.

15. The storage cover of claim 1, further comprising:
a lighting unit configured to emit light into the storage space; and
one or more third light guides configured such that the light emitted from the lighting unit is transmitted therethrough, propagated along a widthwise direction of the cover unit, and diffused toward the cover unit.

16. The storage cover of claim 15, wherein the third light guides are fixed along a widthwise direction of the cover unit, and light from the lighting unit is incident on an end portion of each of the third light guides.

17. The storage cover of claim 15, wherein the third light guides are continuously arranged at predetermined intervals along the longitudinal direction of the cover unit, and
wherein the lighting unit is individually provided for each of the third light guides so that light is incident thereon.

18. The storage cover of claim 15, further comprising:
rails configured to guide sliding of the cover unit on left and right sides of the cover unit, each of the rails having projection holes at portions respectively facing the third light guides,
wherein light emitted from the lighting unit is incident on the third light guides through the projection holes, and
wherein each of the projection holes has an inner diameter that expands toward a corresponding one of the third light guides.

19. The storage cover of claim 15, wherein the third light guides are each disposed at a position corresponding to the lighting unit in response that the storage space is closed by the cover unit.

20. The storage cover of claim 1, further comprising:
a sensor configured to detect whether the storage space is opened or closed by the cover unit; and
a controller configured to control on/off operation of the lighting unit in response to opening or closing of the storage space.
